(19) United States
(12) Patent Application Publication
(10) Pub. No.: US 2007/0148540 A1
(43) Pub. Date: Jun. 28, 2007

(54) Nonaqueous electrolyte for secondary battery and nonaqueous electrolyte secondary battery

(76) Inventors: Takanobu Chiga, Kobe-city (JP); Yoshinori Kida, Kobe-city (JP)

Correspondence Address: KUBOVCIK & KUBOVCIK, SUITE 710, 900 17TH STREET NW, WASHINGTON, DC, 20006, US

(21) Appl. No.: 11/526,609

(22) Filed: Sep. 26, 2006

(30) Foreign Application Priority Data
Sep. 26, 2005 (JP) 2005-278107

(51) Int. Cl. H01M 10/40; H01M 4/48; H01M 4/52

(52) U.S. Cl. 429/200; 429/326; 429/231.1; 429/231.3

(57) ABSTRACT

A nonaqueous electrolyte for a secondary battery is disclosed which contains at least 10% by volume of methyl difluoroacetate, based on a total volume of a solvent. The nonaqueous electrolyte uses, as a mixed solute, at least one A electrolyte salt selected from LiPF₆ and LiBF₄ and at least one B electrolyte salt selected from LiN(CₗF₂ₗ₊₁SO₂)(CₘF₂ₘ₊₁SO₂) (wherein l and m independently indicate an integer of at least 0) and LiC(CₚF₂ₚ₊₁SO₂)(C_{q}F_{2q+1}SO₂)(CᵣF₂ᵣ₊₁SO₂) (wherein p, q and r independently indicate an integer of at least 0).

### BACKGROUND OF THE INVENTION

1. Technical Field

The present invention relates to a nonaqueous electrolyte for a secondary battery and a nonaqueous electrolyte secondary battery, more particularly to a nonaqueous electrolyte for a secondary battery which uses methyl difluoroacetate as an electrolyte solvent and a nonaqueous electrolyte secondary battery.

2. Description of Related Art

In recent years, nonaqueous electrolyte secondary batteries using metallic lithium, an alloy capable of storing and releasing lithium or carbon material as the negative active material and a lithium-containing transition metal oxide represented by the chemical formula LiMO₂ (M is a transition metal) as the positive electrode material have been noted as high-energy-density batteries.

As the nonaqueous electrolyte, those containing a lithium salt, such as LiPF₆, LiBF₄ or LiClO₄, dissolved in an aprotic organic solvent have been generally used. Examples of useful aprotic solvents include carbonates such as propylene carbonate, ethylene carbonate, diethyl carbonate and ethyl methyl carbonate; esters such as r-butyrolactone and methyl acetate; and ethers such as diethoxyethane.

Among such solvents, methyl difluoroacetate (CHF₂COOCH₃) obtained via fluorination of methyl acetate (CH₃COOCH₃) shows low reactivity with a charged positive or negative electrode and is thus effective to improve thermal stability of a battery, as is reported by Jun-ichi Yamaki, Ikiko Yamazaki, Minato Egashira and Shigeto Okada, J. Power Source, 102, 288 (2001); Kazuya Sato, Iiko Yamazaki, Shigeto Okada and Jun-ichi Yamaki, Solid State Ionics, 148, 463 (2002); and Japanese Patent Laid-Open No. Hei 8-298134.

However, in the case where methyl difluoroacetate is used as a solvent for a nonaqueous electrolyte secondary battery according to the above literatures, if LiPF₆ is used alone as an electrolyte salt, it has been found difficult to obtain satisfactory charge-discharge characteristics. Presumably, the incorporation of LiPF₆ induces a side reaction between methyl difluoroacetate and chemical species produced in the electrolyte, such as HF and PF₅. If LiN(CₗF₂ₗ₊₁SO₂)(CₘF₂ₘ₊₁SO₂) (wherein l and m independently represent an integer of at least 0) or LiC(CₚF₂ₚ₊₁SO₂)(C_{q}F_{2q+1}SO₂)(CᵣF₂ᵣ₊₁SO₂) (wherein p, q and r independently indicate an integer of at least 0) is used alone as an electrolyte salt, dissolution of an aluminum current collector occurs while decomposition of methyl difluoroacetate is suppressed, which has been a problem.

Japanese Patent Laid-Open No. Hei5-62690 proposes a method for suppressing self-discharge by using a mixed electrolyte salt containing LiBF₄ and LiN(CF₃SO₂)₂ and a solvent comprising propylene carbonate and 1,2-dimethoxyethane. However, neither description nor suggestion is provided as to the charge-discharge characteristics improvement that can be achieved when methyl difluoroacetate is used as a solvent.

As described above, conventional batteries using methyl difluoroacetate as a solvent of a nonaqueous electrolyte have failed to obtain sufficient charge-discharge characteristics, although methyl difluoroacetate is expected to exhibit high thermal stability and contribute to improvements in safety of batteries.

### SUMMARY OF THE INVENTION

It is an object of the present invention to provide a nonaqueous electrolyte which uses methyl difluoroacetate as a solvent and, when used in a nonaqueous electrolyte secondary battery, can improve its charge-discharge characteristics, and also provide a nonaqueous electrolyte secondary battery using the nonaqueous electrolyte.

The nonaqueous electrolyte for a secondary battery, in accordance with the present invention, is characterized as containing at least 10% by volume, preferably at least 50% by volume of methyl difluoroacetate, based on a total amount of a solvent, and a mixed solute comprising at least one A electrolyte salt selected from LiPF₆ and LiBF₄ and at least one B electrolyte salt selected from LiN(CₗF₂ₗ₊₁SO₂)(CₘF₂ₘ₊₁SO₂) (in the formula, l and m independently indicate an integer of at least 0) and LiC(CₚF₂ₚ₊₁SO₂)(C_{q}F_{2q+1}SO₂)(CᵣF₂ᵣ₊₁SO₂) (in the formula, p, q and r independently indicate an integer of at least 0).

The use of the A and B electrolyte salts as a mixed solute, in accordance with the present invention, improves charge-discharge characteristics of the nonaqueous electrolyte.

In the case where an aluminum current collector is used as the positive current collector, the A electrolyte salt if contained acts to form a protective film on the aluminum current collector and prevent dissolution of aluminum. The inclusion of the B electrolyte salt increases an electrical conductivity of the electrolyte and also retards a reaction between the A electrolyte salt and methyl difluoroacetate, while its detail is not clear.

In the present invention, the ratio (A:B) by mole of the A electrolyte salt to the B electrolyte salt is preferably 5:95-95:5, more preferably 10:90-90:10.

In the present invention, a total molar concentration of the A and B electrolyte salts is preferably 0.7-1.5 mole/liter. Also, the A electrolyte salt is preferably contained within the range of 0.05-1.2 mole/liter, more preferably within the range of 0.1-0.9 mole/liter.

If the A electrolyte salt content is excessively small, a sufficient protective film may not be formed on the aluminum current collector to result in the failure to obtain good charge-discharge characteristics. On the other hand, if the A electrolyte salt content is excessively large, methyl difluoroacetate may be decomposed via a reaction thereof with the A electrolyte salt to result in the failure to obtain satisfactory charge-discharge characteristics.

The B electrolyte salt is preferably contained within the range of 0.05-1.2 mole/liter, more preferably within the range of 0.1-0.9 mole/liter. If the B electrolyte salt content is excessively small, a sufficient electrical conductivity may not be obtained to result in the failure to provide satisfactory charge-discharge characteristics. On the other hand, if the B electrolyte salt content is excessively large, a viscosity of the electrolyte may be increased to result in the failure to obtain satisfactory charge-discharge characteristics.

In the present invention, highly conductive LiPF₆ is particularly preferably used as the A electrolyte salt.

LiN(CₗF₂ₗ₊₁SO₂)(CₘF₂ₘ₊₁SO₂) (wherein l and m independently indicate an integer of at least 0) is preferably used as the B electrolyte salt. It is particularly preferred when l and m in the formula are 1 or 2, independently. This is because the presence of excessively larger anions increases a viscosity coefficient and thus lowers an electrical conductivity of the electrolyte. It also becomes very advantageous cost-wise.

Also in the present invention, the nonaqueous electrolyte preferably contains a cyclic carbonate ester compound having a C═C unsaturated bond since a part of methyl difluoroacetate is reductively decomposed on a negative electrode during initial charging. Examples of such compounds include vinylene carbonate, 4,5-dimethylvinylene carbonate, 4,5-diethyl-vinylene carbonate, 4,5-dipropylvinylene carbonate, 4-ethyl-5-methylvinylene carbonate, 4-ethyl-5-propylvinylene carbonate, 4-methyl-5-propylvinylene carbonate, vinyl-ethylene carbonate and divinylethylene carbonate. Vinylene carbonate and vinylethylene carbonate, among them, are particularly preferred for their ability to form a fine film on a negative electrode and suppress decomposition of methyl difluoroacetate.

The cyclic carbonate ester compound having a C═C unsaturated bond is preferably contained in the amount of 0.5-15 parts by weight, more preferably 1-10 parts by weight, based on 100 parts by weight of the nonaqueous electrolyte. If its content is excessively small, decomposition of methyl difluoroacetate on a negative electrode may not be suppressed sufficiently, possibly resulting in the failure to obtain satisfactory charge-discharge characteristics. On the other hand, if its content is excessively large, a thicker film is formed on a negative electrode surface to increase a reaction resistance of the negative electrode, possibly resulting in deterioration of charge-discharge characteristics.

Examples of solvents useful in the present invention, other than methyl difluoroacetate and cyclic carbonate ester compounds having a C═C unsaturated bond, include cyclic carbonate esters such as ethylene carbonate, propylene carbonate, 1,2-butylene carbonate and 2,3-butylene carbonate; cyclic esters such as γ-butyrolactone and propanesultone; chain carbonate esters such as ethyl methyl carbonate, diethyl carbonate and dimethyl carbonate; and chain ethers such as 1,2-dimethoxyethane, 1,2-diethoxyethane, diethyl ether and ethyl methyl ether. Other applicable solvents include methyl acetate, ethyl acetate, propyl acetate, methyl propionate, ethyl propionate, tetrahydrofuran, 2-methyltetrahydrofuran, 1,4-dioxane and acetonitrile.

The nonaqueous electrolyte secondary battery of the present invention is characterized as including a positive electrode, a negative electrode and the aforesaid nonaqueous electrolyte of the present invention.

The nonaqueous electrolyte secondary battery of the present invention exhibits satisfactory charge-discharge characteristics because it uses the aforesaid nonaqueous electrolyte of the present invention.

Any material which can store and release lithium may be used as an active material of a negative electrode for the secondary battery of the present invention. Examples include lithium alloys such as metallic lithium, lithium-aluminum alloy, lithium-lead alloy, lithium-silicon alloy and lithium-tin alloy; carbon materials such as graphite, coke, burned organics; and metal oxides which are more base in potential than the positive active material, such as SnO₂, SnO and TiO₂. The use of carbon materials, among them, is preferred for their ability to form a fine film on their surfaces in the nonaqueous electrolyte containing methyl difluoroacetate. These may be mixed by a conventional technique with a binder, such as polyterafluoroethylene (PTFE), polyvinylidene fluoride (PVdF) or styrene-butadiene rubber (SBR), to provide a mixture for use as an anode mix.

Any material can be used as the active material of the positive electrode in the secondary battery of the present invention, so long as it is useful as the positive active material for nonaqueous electrolyte secondary batteries. Examples of useful materials include lithium-containing transition metal oxides having a layered or spinel structure, and lithium-containing transition metal phosphates having an olivin structure. For the reason of high energy density, the use of lithium cobaltate or other lithium-containing transition metal oxides having a layered structure, among them, is preferred. These may be mixed with an electrical conductor, such as acetylene black or carbon black, and a binder such as polytetrafluoroethylene (PTFE) or polyvinylidene fluoride (PVdF) to provide a mixture for use as a cathode mix.

Besides the A and B electrolyte salts, the nonaqueous electrolyte of the present invention in secondary batteries may further contain a lithium salt as a solute. Examples of lithium salts include LiB(C₂O₄)₂, Li[B(C₂O₄)F₂], Li[P(C₂O₄)F₄] and Li[P(C₂O₄)₂F₂].

The inclusion of the A and B electrolyte salts in a nonaqueous electrolyte containing methyl difluoroacetate, according to the present invention, improves charge-discharge characteristics of a nonaqueous electrolyte secondary battery.

Also, the use of methyl difluoroacetate as a solvent improves thermal stability.

### DESCRIPTION OF THE PREFERRED EXAMPLES

The present invention is below described in more detail by way of examples which are not intended to be limiting thereof. Suitable changes and modifications can be effected without departing from the scope of the present invention.

### Example 1

(Fabrication of Positive Electrode)

LiCoO₂ as a positive active material and a carbon material as an electrical conductor were added to an N-methyl-2-pyrrolidone solution containing a polyvinylidene fluoride binder dissolved therein such that the ratio by weight of the active material, electrical conductor and binder was brought to 95:2.5:2.5. They were then kneaded to prepare a cathode mix slurry. The prepared slurry was coated on an aluminum foil as a current collector, dried and then rolled by a pressure roll. Subsequent attachment of a current collecting tab completed fabrication of a positive electrode.

(Fabrication of Negative Electrode)

Graphite as a negative active material and SBR as a binder were added to an aqueous solution of carboxymethylcellulose as a thickener such that the ratio by weight of the active material, binder and thickener was brought to 97.5:1.5:1. They were then kneaded to prepare an anode mix slurry. The prepared slurry was applied onto a copper foil as a current collector, dried and rolled by a pressure roll. Subsequent attachment of a current collecting tab completed fabrication of a negative electrode.

(Preparation of Electrolyte Solution)

Methyl difluoroacetate was used as a solvent. LiN(CF₃SO₂)₂(=LiTFSI) and LiPF₆, each as an electrolyte salt, were dissolved at concentrations of 0.9 mole/liter and 0.1 mole/liter in the solvent to prepare a nonaqueous electrolyte solution. Then, 2 parts by weight of vinylene carbonate and 2 parts by weight of vinylethylene carbonate were added to 100 parts by weight of the nonaqueous electrolyte solution.

(Construction of Battery)

The positive and negative electrodes, as fabricated in the fashions as described above, were wound, while interposing a polyethylene separator between them, to provide a wound electrode assembly. In a glove box maintained under an Ar (argon) atmosphere, this wound electrode assembly and the electrolyte solution were encapsulated in a battery can. As a result, a nonaqueous electrolyte secondary battery A was constructed having a cylindrical 18650 size.

### Example 2

The procedure of Example 1 was followed, except that LiN(CF₃SO₂)₂(=LiTFSI) and LiPF₆, each as an electrolyte salt, were dissolved at concentrations of 0.8 mole/liter and 0.2 mole/liter in the solvent, to construct a nonaqueous electrolyte secondary battery B of a cylindrical 18650 size.

### Example 3

The procedure of Example 1 was followed, except that LiN(CF₃SO₂)₂(=LiTFSI) and LiPF₆, each as an electrolyte salt, were dissolved at concentrations of 0.5 mole/liter and 0.5 mole/liter in the solvent, to construct a nonaqueous electrolyte secondary battery C of a cylindrical 18650 size.

### Comparative Example 1

The procedure of Example 1 was followed, except that LiN(CF₃SO₂)₂(=LiTFSI) as an electrolyte salt was dissolved at a concentration of 1 mole/liter in the solvent, to construct a nonaqueous electrolyte secondary battery D of a cylindrical 18650 size.

### Comparative Example 2

The procedure of Example 1 was followed, except that LiPF₆ as an electrolyte salt was dissolved at a concentration of 1 mole/liter in the solvent, to construct a nonaqueous electrolyte secondary battery E of a cylindrical 18650 size.

### Comparative Example 3

A solvent was used containing ethylene carbonate (EC) and ethyl methyl carbonate (EMC) in the ratio by volume of 30:70. LiN(CF₃SO₂)₂(=LiTFSI) as an electrolyte salt was dissolved at a concentration of 1 mole/liter in the solvent to prepare a nonaqueous electrolyte solution. Subsequently, 2 parts by weight of vinylene carbonate was added to 100 parts by weight of the nonaqueous electrolyte solution. Otherwise, the procedure of Example 1 was followed to construct a nonaqueous electrolyte secondary battery F of a cylindrical 18650 size.

### Comparative Example 4

A solvent was used containing ethylene carbonate (EC) and ethyl methyl carbonate (EMC) in the ratio by volume of 30:70. LiN(CF₃SO₂)₂(=LITFSI) and LiPF₆, each as an electrolyte salt, were dissolved at concentrations of 0.9 mole/liter and 0.1 mole/liter in the solvent to prepare a nonaqueous electrolyte solution. Then, 2 parts by weight of vinylene carbonate was added to 100 parts by weight of the nonaqueous electrolyte solution. Otherwise, the procedure of Example 1 was followed to construct a nonaqueous electrolyte secondary battery G of a cylindrical 18650 size.

### Comparative Example 5

A solvent was used containing ethylene carbonate (EC) and ethyl methyl carbonate (EMC) in the ratio by volume of 30:70. LiN(CF₃SO₂)₂(=LITFSI) and LiPF₆, each as an electrolyte salt, were dissolved at concentrations of 0.5 mole/liter and 0.5 mole/liter in the solvent to prepare a nonaqueous electrolyte solution. Then, 2 parts by weight of vinylene carbonate was added to 100 parts by weight of the nonaqueous electrolyte solution. Otherwise, the procedure of Example 1 was followed to construct a nonaqueous electrolyte secondary battery H of a cylindrical 18650 size.

### Comparative Example 6

A solvent was used containing ethylene carbonate (EC) and ethyl methyl carbonate (EMC) in the ratio by volume of 30:70. LiPF₆ as an electrolyte salt was dissolved at a concentration of 1 mole/liter in the solvent to prepare a nonaqueous electrolyte solution. Then, 2 parts by weight of vinylene carbonate was added to 100 parts by weight of the nonaqueous electrolyte solution. Otherwise, the procedure of Example 1 was followed to construct a nonaqueous electrolyte secondary battery I of a cylindrical 18650 size.

Evaluation of Battery Characteristics

Each of the above-constructed nonaqueous electrolyte secondary batteries was charged at a constant current (0.2 C) and further at a constant voltage (0.02 C, cut) to a voltage of 4.2 V to thereby measure an initial charge capacity C₁. The battery was then discharged at a constant current (0.2 C) to 2.75 V to thereby measure an initial discharge capacity D₁. The values for C₁ and D₁ were inserted into the following equation to determine an initial efficiency (i) of the battery.
Initial efficiency(%)=(D₁/C₁)×100

The above-specified charge-discharge cycle was repeated 3 times. A 0.2 C discharge capacity on the third cycle was determined and designated as D_{0.2C}.

Also, each battery was charged at a constant current (1 C) and further at a constant voltage (0.02 C, cut) to a voltage of 4.2 V and then discharged at a constant current (2 C) to 2.75 V to thereby measure a 2 C discharge capacity D₂C. A ratio (%) of discharge loads was calculated from D_{0.2C} and D_{2C}.
Discharge load ratio(%)=(D₂C/D_{0.2C})×100

The initial discharge capacity, initial efficiency and discharge load ratio, determined for each of the constructed nonaqueous electrolyte secondary batteries, are listed in Tables 1 and 2. In Tables 1 and 2, the initial discharge capacity is given by a standardized value when the initial discharge capacity value measured in Comparative Example 6 is taken as 100.

TABLE 1

| | | | Initial | Initial | Discharge |
|---|---|---|---|---|---|
| | | | Discharge | Efficiency | Load Ratio (%) |
| | Battery | Electrolyte Salt | Capacity | (%) | (2 C/0.2 C) |
| Ex. 1 | A | 0.9 M LiTFSI + 0.1 M LiPF₆ | 96.2 | 88.6 | 91.8 |
| Ex. 2 | B | 0.8 M LiTFSI + 0.2 M LiPF₆ | 96.1 | 88.5 | 88.4 |
| Ex. 3 | C | 0.5 M LiTFSI + 0.5 M LiPF₆ | 95.3 | 87.9 | 89.8 |
| Comp. | D | 1 M LiTFSI | 96.8 | 88.6 | 85.6 |
| Ex. 1 | | | | | |
| Comp. | E | 1 M LiPF₆ | 94.9 | 87.7 | 90.8 |
| Ex. 2 | | | | | |

TABLE 2

| | | | | |
|---|---|---|---|---|
| | | Initial | Initial | Discharge |
| | | Discharge | Efficiency | Load Ratio (%) |
| Battery | Electrolyte Salt | Capacity | (%) | (2 C/0.2 C) |

| | | | | | |
|---|---|---|---|---|---|
| Comp. | F | 1 M LiTFSI | 0.1 | 0.2 | — |
| Ex. 3 | | | | | |
| Comp. | G | 0.9 M LiTFSI + 0.1 M LiPF₆ | 100.3 | 93.6 | 96.8 |
| Ex. 4 | | | | | |
| Comp. | H | 0.5 M LiTFSI + 0.5 M LiPF₆ | 100.2 | 93.4 | 96.8 |
| Ex. 5 | | | | | |
| Comp. | I | 1 M LiPF₆ | 100 | 93.6 | 96.4 |
| Ex. 6 | | | | | |

As can be seen from Table 1, in the case where methyl difluoroacetate is used as a solvent, if LiTFSI alone is used as in the case of Comparative Example 1 (D), the discharge load ratio decreases to result in the failure to obtain satisfactory charge-discharge characteristics. When the battery D of Comparative Example 1 was disassembled, the aluminum current collector was found brittle. It is accordingly presumed that the exclusion of LiPF₆ allowed the aluminum current collector to dissolve partly and reduce its current collecting capability and, as a result, deteriorated load characteristics.

The use of LiPF₆ alone, as in the case of Comparative Example 2 (E), retards dissolution of the aluminum current collector to thereby improve the discharge load ratio, but it reduces the initial discharge capacity and initial efficiency to result in the failure to obtain satisfactory charge-discharge characteristics. This is due presumably to the inclusion of LiPF₆ alone that allows the occurrence of a side reaction between chemical species produced in the electrolyte solution, such as HF or PF₅, and methyl difluoroacetate.

However, it has been found that Examples 1 (A)-3 (C) using LiTFSI and LiPF₆ in combination exhibit higher discharge load ratios while maintaining comparable initial discharge capacity and initial efficiency values, compared to Comparative Example 1 (D) using LiTFSI alone. This is probably because the use of LiTFSI and LiPF₆ in combination retards a reaction between LiPF₆ and methyl difluoroacetate and results in obtaining high initial discharge capacity and initial efficiency values. Also, it is believed that, due to the inclusion of LiPF₆, a protective film is formed on the aluminum current collector to retard dissolution thereof and, due to further inclusion of LiTFSI, the high discharge load ratio is obtained.

The use of LiTFSI alone in the conventional EC/EMC solvent, as in the case of Comparative Example 3(F) in Table 2, causes dissolution of the aluminum current collector and prevents charge and discharge. On the other hand, the use of LiPF₆, as in the cases of Comparative Examples 4 (G)-6 (I), retards dissolution of the aluminum current collector and enables charge and discharge. However, additional use of LiTFSI, i.e., the use of LiPF₆ and LITFSI in combination as an electrolyte salt little increases values for initial discharge capacity, initial efficiency and discharge load ratio, as contrary to batteries using a solvent containing methyl difluoroacetate.

It is therefore recognized that the charge-discharge characteristics improving effect, as obtained when the A and B electrolyte salts are used in combination, is a unique one which is achievable only when a solvent containing methyl difluoroacetate is used.

In the above Examples, charge-discharge characteristics are observed for batteries constructed using LiCoO₂ as the positive active material and graphite as the negative active material. However, the same results are obtained for batteries using the positive active material such as Li(Ni, Co, Mn)O₂, LiMn₂O₄ or LiFePO₄ and the negative active material such as an alloy capable of storing and releasing lithium ions. Also in the above Examples, evaluations were made for cylindrical batteries. However, the battery is not particularly limited in shape and may have square, flat and other shapes. The present invention can be applied to nonaqueous electrolyte secondary batteries having various shapes and configurations.

What is claimed is:

1. A nonaqueous electrolyte for a secondary battery which contains at least 10% by volume of methyl difluoroacetate, based on a total volume of a solvent, said nonaqueous electrolyte being characterized in that it contains, as a mixed solute, at least one A electrolyte salt selected from LiPF₆ and LiBF₄ and at least one B electrolyte salt selected from LiN(CₗF₂ₗ₊₁SO₂)(CₘF₂ₘ₊₁SO₂) (wherein l and m independently indicate an integer of at least 0) and LiC(CₚF₂ₚ₊₁SO₂)(C_{q}F_{2q+1}SO₂)(CᵣF₂ᵣ₊₁SO₂) (wherein p, q and r independently indicate an integer of at least 0).

2. The nonaqueous electrolyte for a secondary battery as recited in claim 1, characterized in that said A and B electrolyte salts are mixed in the ratio (A:B) by mole of 5:95-95:5.

3. The nonaqueous electrolyte for a secondary battery as recited in claim 1, characterized in that said methyl difluoroacetate is contained in the amount of at least 50% by volume, based on a total volume of the solvent.

4. The nonaqueous electrolyte for a secondary battery as recited in claim 1, characterized in that a total molar concentration of said A and B electrolyte salts is 0.7-1.5 mole/liter.

5. The nonaqueous electrolyte for a secondary battery as recited in claim 1, characterized in that said A electrolyte salt is LiPF₆ and said B electrolyte salt is LiN(CₗF₂ₗ₊₁SO₂)(CₘF₂ₘ₊₁SO₂) (wherein l and m independently indicate an integer of at least 0).

6. The nonaqueous electrolyte for a secondary battery as recited in claim 1, characterized in that said A electrolyte salt is LiPF₆ and said B electrolyte salt is LiN(CF₃SO₂)₂.

7. The nonaqueous electrolyte for a secondary battery as recited in claim 1, characterized in that it further contains vinylene carbonate.

8. The nonaqueous electrolyte for a secondary battery as recited in claim 1, characterized in that it further contains vinylethylene carbonate.

9. A nonaqueous electrolyte secondary battery characterized as including a positive electrode, a negative electrode and the nonaqueous electrolyte recited in claim 1.

10. The nonaqueous electrolyte secondary battery as recited in claim 9, characterized in that said positive electrode contains, as its active material, a lithium-containing transition metal oxide having a layered structure.

11. The nonaqueous electrolyte secondary battery as recited in claim 10, characterized in that said lithium-containing transition metal oxide is lithium cobaltate.
